(19) United States
(12) Patent Application Publication
(10) Pub. No.: US 2014/0149291 A1
(43) Pub. Date: May 29, 2014

(54) SYSTEM AND METHOD FOR ELECTRONIC COMMERCE

(71) Applicant: James Bercaw, Playa Del Rey, CA (US)

(72) Inventor: James Bercaw, Playa Del Rey, CA (US)

(21) Appl. No.: 14/159,378

(22) Filed: Jan. 20, 2014

Related U.S. Application Data
(63) Continuation-in-part of application No. 12/932,997, filed on Mar. 11, 2011.

(51) Int. Cl. G06Q 20/12; G06Q 20/40

(52) U.S. Cl. CPC G06Q 20/12; G06Q 20/4014
USPC 705/44

(57) ABSTRACT

A method for secure electronic commercial transactions that uses a networked payment server to communicate a pre-defined purchase ticket to a registered buyer of the payment server in response to a purchase request received over a network that identifies the registered buyer and a registered seller of the payment server with whom the registered buyer is entering into a commercial transaction.

This application is a continuation-in-part of prior U.S. non-provisional patent application Ser. No. 12/932,997 filed on Mar. 11, 2011, the contents of which are hereby incorporated by reference, and for which the benefit of priority under 35 U.S.C. §120 is claimed.

### BACKGROUND OF THE INVENTION

The present invention is in the area of electronic commerce, and more particularly pertains to systems and methods to facilitate the purchase of products with mobile networked computing devices, such as for example mobile telephone and tablet devices, that are in communication with a payment server.

Mobile telephones have recently transitioned from being perceived to be luxury or gadget items to indispensable appliances which are critical to the day-to-day functions of society. In point of fact, in some urban areas, mobile telephones are replacing landlines altogether. The number of US households exclusively using mobile telephones and eschewing the use of landlines is growing rapidly. In 2008, worldwide mobile telephone subscriptions surpassed 4 billion.

The reason for this trend is manifold. Most mobile telephones are now packaged with substantial computing processing power and storage space. What's more is the fact that many mobile telephones are enabled for wireless Internet access (e.g. Wi-Fi). This ubiquitous computer and telephone network access has allowed many people to work anywhere. This freedom enables many people to monitor their emails, communicate with co-workers, friends and relatives from virtually anywhere they go. In addition, many users are availing themselves of the ability to purchase various products and services on-line through their mobile devices.

Tracking alongside the explosion of use of mobile devices is electronic commerce. The growth of on-line sales has multiplied in recent years. Not surprisingly, on-line retailers have not only noticed increased sales originating from desktop computers, but have also noticed strong growth in the use of mobile devices to do on-line shopping (e.g. research and acquire products over the Internet from sellers). Rapid technological advances in mobile devices have helped to facilitate this increase in on-line shopping. For example, many mobile devices now have the ability to conveniently acquire images (i.e. scan) and process machine-readable codes (e.g. bar codes) displayed in connection with a seller's offered products or services. This makes it easier and quicker for the user of a mobile device to acquire and communicate information concerning a product or service as compared to having manually key in the information that is encoded by a bar code.

Moreover, the user of a mobile device with network access presents the opportunity for the user to rapidly acquire (e.g. in real-time) information that may be relevant to a product or service the user of the mobile device is considering purchasing or using. There are thus opportunities for up-selling, suggestive selling, advertisements, coupons, promotions, and other product messages that may directly target a user of a mobile device in real time who are in the process of purchasing goods or services. However, currently most credit card, or debit card services provided little ancillary value in exchange for their standard transaction fees.

Therefore, what is clearly needed in the art is a method and system for enabling enhanced electronic commerce using today's ubiquitous mobile devices. Such a method and system should be simple, secure, and preferably provide value added financial transactions which enable sellers, and registered advertisers to increase sales through direct promotional materials to a user's mobile device via an installed payment application on such mobile device.

### BRIEF SUMMARY OF THE INVENTION

The present invention is a method for electronic commerce that has an object the use of a networked payment server executing a transaction processing application (also referred to hereinafter in abbreviated form as the “TPA”) that enables the payment server to communicate over one or more networks with a payment application (also referred to hereinafter in abbreviated form as a “PA”) executed on a networked computing device (also referred to hereinafter in abbreviated form as a “NCD”) of a user registered with the payment server who is engaging in a purchase transaction with another registered user.

In a preferred embodiment of the present invention, both the buyer and the seller in a transaction are registered users of the payment server. Each registered user of the payment server has a unique user identifier that is stored in the memory of the payment server to identify the user.

A registered user who is interested in making a purchase of a good or service is the “buyer” in a transaction, while the registered user who is selling the good or service is the “seller” in the transaction. It is contemplated in a preferred embodiment of the present invention that a registered user may use the PA to complete a transaction with another registered user as either a buyer or seller depending upon the mode of operation of the PA on the user NCD.

A registered user who is interested in completing a transaction with another registered user activates the PA on the user's NCD (e.g. the user's smart phone). The user then inputs a mode selection to the PA to choose a buyer mode or a seller mode. If the user is going to be making a purchase from another registered user then the user would be a buyer and select the buyer mode for the PA. The other registered user would activate the PA on their networked computing device and select seller mode. It should be noted that a registered user can set the PA to a default mode of either buyer or seller that the PA will automatically enter into upon activation by the user.

If the PA is active in buyer mode it will execute instructions to cause the buyer NCD to receive the user identifier of the seller (“seller ID”) that is used by the payment server to identify the seller. In a preferred embodiment the buyer NCD receives the seller ID through a camera system of the buyer NCD scanning a machine-readable code (e.g. a bar code) that is displayed by the seller (e.g. on a merchandise label, signage, seller NCD, etc. . . . ). In addition to receiving the seller ID, the buyer NCD may also receive coupons (e.g. through scanning a barcode for the coupon which may also include the seller ID) the buyer is interested in using. Upon receiving the seller ID and any coupons the buyer NCD ciphers (i.e. encodes) a purchase request from the user identifier of the buyer (“buyer ID”) that is used by the payment server to identify the buyer, the seller ID, and any received coupon information. It is contemplated that the identifier of a registered user may be stored in memory of the user's NCD for access and use by the PA. The buyer NCD communicates the purchase request over a network, such as a telephone or computer network, to the payment server.

The payment server deciphers the purchase request to parse and identify the buyer ID, seller ID, and any coupon information. The payment server verifies from account records in memory that the received buyer ID and seller ID are valid for active registered users. Upon successful verification of the user IDs the payment server selects a unique base code (“purchase ticket”) from server memory and communicates the purchase ticket to the buyer NCD over a network. In a preferred embodiment the purchase ticket is identified in payment server memory as pending for a transaction between the identified buyer and seller, and may also have associated with it any coupon information that was contained in the purchase request.

The buyer NCD receives the purchase ticket communicated by the payment server. The instructions in the PA then cause the buyer NCD to prompt the buyer and to receive a buyer validation input for confirming and proceeding with the transaction. In a preferred embodiment it is contemplated that the buyer validation input includes at least a buyer personal identification code (“PIC”), and a currency amount for the transaction. The account record of the buyer that is stored in memory of the payment server contains the buyer PIC (which may be made up of numbers, letters, and/or symbols), which is preferably otherwise known only to buyer, and not stored by the PA in the buyer NCD. Upon receiving the buyer PIC and buyer validation input the PA instructions cause the buyer NCD to cipher a settlement code, preferably encrypted, from the received purchase ticket, the buyer PIC, and the buyer validation input. The buyer NCD communicates the settlement code to the seller NCD, preferably by the buyer NCD displaying on a display of the buyer NCD the settlement code as a machine-readable code (e.g. a bar code) for scanning by the seller NCD.

A PA being executed in seller mode by the seller NCD will cause the seller NCD to receive the settlement code from the buyer NCD (e.g. through scanning the settlement code bar code displayed by the buyer NCD). The PA instructions then preferably cause the seller NCD to prompt seller and receive a seller validation input, which in a preferred contemplated embodiment is expected to match the buyer validation input. Thus, for example the seller input validation may be a manual entry by the seller on a physical or virtual keyboard of the currency amount for the transaction. In a preferred contemplated embodiment the seller PA instructions cause the seller NCD to determine that the seller validation input matches the buyer validation input. Upon the seller NCD determining that seller input validation matches the buyer input validation the seller PA instructions then cause the seller NCD to cipher a payment request code, preferably encrypted, from the settlement code received from the buyer NCD such that the payment request code will include a ciphered purchase ticket, buyer PIC, and transaction amount. The seller NCD communicates the payment request code over a network to the payment server. In an alternative embodiment the seller NCD transmits the buyer validation input and seller validation input with or as part of the payment request code such that payment server 10 may determine if the buyer and seller validation inputs match. In such an alternative embodiment the seller NCD may or may not also determine if the buyer validation input matches the seller validation input

The payment server receives the payment request code and the instructions of the TPA cause the payment server to decipher the payment code to obtain at least the contained purchase ticket, the buyer PIC, and buyer validation input. The TPA instructions cause the payment server to verify the buyer PIC in the buyer validation input using the account record for the buyer stored in payment server memory. In embodiments where the payment request code contains both the buyer validation and seller validation the TPA instructions cause the payment server to verify that the buyer validation input matches the seller validation input (e.g. the currency amount for the transaction matches). The TPA instructions cause the payment server to verify that the purchase ticket from the settlement code matches a purchase ticket stored in server memory as pending for a transaction between the buyer and seller. The TPA instructions cause the payment server to verify that buyer funds or credit available are sufficient for the transaction.

The TPA instructions cause the payment server to communicate over a network a payment confirmation message to the seller NCD. The payment confirmation message may communicate information confirming that the transaction was successfully completed, or communicate information that the transaction was unable to be completed. The payment server also communicates over a network a purchase confirmation message to the buyer NCD. The purchase confirmation message may communicate information confirming that the transaction was successfully completed, or communicate information that the transaction was unable to be completed.

Another object of the method of the present invention is to communicate relevant product and promotional information to a buyer NCD who is initiating or completing a transaction using the payment server. To achieve this object the payment server may in some preferred embodiments communicate to the buyer NCD a product message concurrently with the transmission of the purchase ticket sent in response to a purchase request, and/or with the purchase confirmation message sent upon completion of a transaction. The product message may contain product or promotional information from the particular seller the buyer is transacting business with, and/or from other advertising registered users of the payment server. Such product message may also take into account any coupon or other transaction information that was contained in the purchase request or payment request code received by the payment server.

The present invention offers the advantage of completing a transaction for the purchase of goods or services with communication of a reduced amount of transaction related information. The use of product messages delivered to a buyer NCD can also enhance the shopping experience of a buyer and promote commerce between registered users of the system.

The present invention also offers enhanced security because no information is communicated during a transaction that contains both personally identifiable information of a buyer (e.g. a buyer ID or account number) and the buyer PIC that is needed for completing transactions using buyer funds or credit. Thus, any interception of a transaction communication is unlikely to compromise the security of a buyer's account.

What follows is a more detailed description of preferred embodiments of the method of the present invention.

### BRIEF DESCRIPTION OF THE SEVERAL VIEWS OF THE DRAWINGS

FIG. 1 is a flowchart diagram illustrating an exemplary process of using a contemplated embodiment of the present invention for electronic commerce.

FIG. 2 is an exemplary illustration showing an infrastructure of a payment server, a buyer NCD, and a seller NCD that are all networked.

FIG. 3 is an exemplary illustration of a settlement code, verification of matching buyer validation input and seller input validation, and a payment request code and its constituent elements.

### DETAILED DESCRIPTION OF THE INVENTION

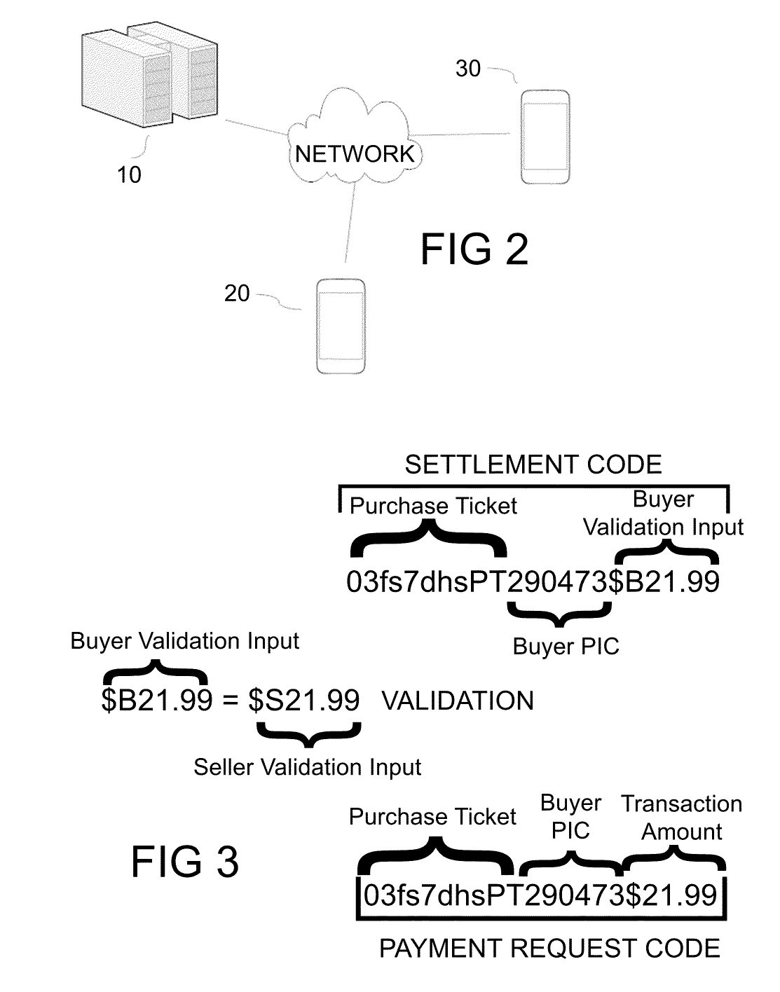

Referring to FIG. 2 the method of the present invention is contemplated to operate using conventional network and wireless infrastructures for communications between a networked payment server 10, a buyer NCD 20, and a seller NCD 30.

By way of example, in a preferred embodiment the buyer NCD 20 and seller NCD 30 may communicate with payment server 10 through a telephone network (e.g. the public switched telephone network) or a computer network (e.g. the Internet). It is contemplated that in an embodiment of the present invention buyer NCD 20 is a portable cellular telephone that may, for example, use short message service (“SMS”) over a cellular telephone network to communicate with payment server 10. In an alternative embodiment buyer NCD 20 is a cellular telephone that may communicate with payment server through the Internet (i.e. using the Internet Protocol) which it may connect to either over a cellular telephone network (e.g. GSM or CDMA), or a Wi-Fi connection (e.g. based on an 802.11 PPAndard of the IEEE).

In any given transaction between a buyer and a seller it is contemplated that seller NCD 30 may communicate with payment server 10 over a communications network pathway that is the same as, or different, than that used by buyer NCD 20. For example, seller NCD 30 may communicate with payment server 10 over a secure Wi-Fi internet connection that buyer NCD 20 does not have permission to access, while buyer NCD 20 communicates with payment server 10 through a cellular telephone network connection to the Internet. Alternatively, by way of example and not limitation, both buyer NCD 20 and seller NCD 30 may communicate with payment server 10 using a cellular telephone network.

In a contemplated preferred embodiment of the invention buyer NCD 20 communicates a settlement code to seller NCD 30 by visually displaying a settlement code on a display of buyer NCD 20 which is then received by seller NCD 30 by the seller NCD scanning the settlement code in the case of a machine-readable code (e.g. a bar code), or manually inputting the settlement code through a device such as a touch screen keyboard. However, other embodiments of the method may have buyer NCD 20 communicate a settlement code to seller NCD 30 through a computer or telephone network connection, or a near field contact less communication connection (e.g. Bluetooth or RFID).

In a preferred embodiment of the method of the present invention payment server 10 is an electronic computer system that is contemplated to comprise at least one server with a memory, a server processor or controller, transaction processing application (“TPA”), and a network interface that connects to at least one communications network. Payment server 10 may comprise a single network server computer, multiple network server computers, or a cloud computing platform, such as for example Amazon Web Services. Payment server memory may include primary operational memory such as RAM and ROM, and also secondary storage memory such as, for example and without limitation, hard disk drives, flash memory drives, optical drives, tape drives, magnetic and optical media (e.g. CD/DVD-ROM, magnetic tape) etc.

In the method of the present invention payment server 10 is contemplated to have at least one database in memory. It is contemplated in a preferred embodiment that there is a first database having at least one data structure in memory that is used by payment server 10 to store account records containing information about registered users.

An account record for a registered user stored in the account record database of payment server 10 includes a unique user identifier (“ID”). Such a unique user ID is used by a user NCD when engaging in purchase transactions using the present invention. Such a unique user ID is contemplated in a preferred embodiment to be information that may be specific to a user NCD 20 (e.g. a cell phone number). Alternatively it may be in the form of a unique user ID (e.g. an alpha-numeric code) that is assigned to, or selected by, a user when registering with payment server 10. It is contemplated that the user ID may be stored in memory of a user NCD in association with, and for use by, a payment application (“PA”) that contains instructions capable of execution by the user NCD to carry out purchase transactions or otherwise communicate with payment server 10. Other account record information may include things such as, by way of example and not limitation, the user's name, user's bank or credit account number, balance of funds available for use, email address, history of transactions, etc. . . . It is contemplated that a user may register with payment server 10, and subsequently access and/or modify some or all of the user account record, through the PA on the buyer NCD, through a website portal to payment server 10 accessible over the Internet, or possibly through a telephone network using a touch tone telephone key pad.

It is further contemplated that in a preferred embodiment of the method of the present invention payment server 10 would have a second purchase ticket database with at least one data structure used for storing a plurality of unique base codes (e.g. each an alpha-numeric string) that are “purchase tickets” used in the present invention. Upon the TPA receiving and verifying a purchase request from a buyer NCD 20 the TPA selects from the purchase ticket database an available purchase ticket for transmission by payment server 10 in response to the purchase request. Once a purchase ticket has been transmitted to a buyer NCD 20 in response to a purchase request it is contemplated that the TPA updates the purchase ticket database to indicate that such purchase ticket is pending for a transaction between the buyer and seller identified in the purchase request and is not available for further use. The status of the purchase ticket as pending may be removed after a predetermined period of time. In some embodiments a purchase ticket that has been selected for use may be limited to a single approved use or transaction.

It is further contemplated that in a preferred embodiment payment server 10 would have a third database having at least one data structure for storing at least one product message (“product message database”). A product message may be any form of information related to the goods or services offered by a seller, including but not limited to information on discounts, promotions, sales, product features, etc. . . . It is contemplated that third party advertisers may register with the payment server so as to have product messages of such advertisers included in the product message database for delivery to other registered users.

The method of the present invention utilizes a user NCD which is contemplated to be a portable electronic communication device that has a computer memory, a computer processor or controller, a software payment application (“PA”) and a network interface to a communications network. In a preferred embodiment the user NCD is a portable electronic device that communicates over a cellular telephone network (e.g. a cell phone or smart phone). However, a user NCD is not limited to devices that operate on telephone networks, but may include other NCDs including by way of example and not limitation any device that can communicate over a connection to the Internet (e.g. through 802.11 Wi-Fi), such as tablets, notebook computers, personal digital assistants, smart watches, etc. . . .

The PA of a user NCD is contemplated to be a software application (i.e. an “app”) that is communicated over a network for installation into the memory of the user NCD for execution by the computer processor of the NCD. The PA contains instructions that are executable on the computer processor of the NCD to cause the NCD to perform the various operations for the completion of a purchase transaction between two registered users of the payment server in accordance with the present invention.

It is contemplated that the communication of the PA over a network to a user NCD for installation may be done directly between payment server 10 and the user NCD (e.g. through a direct communication link between the user NCD and the payment server). Alternatively, the PA may be communicated over a network to a user NCD for installation by or through one or more third parties, such as for example a third party app store (e.g. Apple iTunes, Google Play). Accordingly, if an operator of a payment server of the present invention communicates the PA to a third party network server (e.g. an app store) where it is subsequently communicated by such third party network server to a user's NCD, the operator of the payment server shall still be deemed to have communicated the PA over a network to the user NCD. Furthermore, a communication over a network in general is contemplated to include circumstances where information is communicated through multiple network nodes or parties along a communications pathway between a source and destination. By way of example, and not limitation, it is contemplated that in some embodiments of the present invention the network communications between seller NCD 30 and payment server 10 (e.g. for the payment request code and payment confirmation) may go through a third party merchant account processor of the seller. Such a communication is still considered to be a communication over a network between said seller NCD 30 and said payment server 10.

It is contemplated that upon a user registering with payment server 10 and receiving the PA on their NCD that the user identifier would be stored in PA memory. The PA would be activated by the user when a transaction is contemplated or entered into. In a preferred embodiment of the PA it may operate on a user NCD in either a buyer mode or a seller mode depending upon which side of the transaction the user is on. In such a preferred embodiment it is contemplated that a user has the option to set the PA to a default mode (i.e. either buyer or seller) that is consistent with the role normally occupied by the user in a purchase transaction. However, it is also contemplated that there may be a buyer mode only version of the PA that would be used by dedicated buyers and a seller mode only version of the PA available to dedicated sellers (e.g. retailers). A single mode PA may have features that are unique to the particular role or circumstances of the user. Thus, for example, a seller mode only version of the PA may be designed specifically to integrate with an existing third party retail point-of-sale (also referred to hereinafter as “POS”) system of an established merchant (e.g. as an API).

It is contemplated that in operation a buyer user would activate the PA on the buyer NCD 20. Once activated the PA of the buyer NCD 20 would receive a seller identifier (“seller ID”) for the seller. The seller ID may be acquired through one or more ways depending upon the various input mechanisms that buyer NCD 20 has, and how the seller makes the seller ID available. For example it is contemplated in a preferred embodiment that uses a modern smart phone or tablet device as buyer NCD 20 that a camera system may scan a machine-readable code (e.g. a barcode) that is displayed by the seller either with the merchandise or services desired to be purchased (e.g. a price label), on a seller NCD 30, on a seller website page, or on a physical sign or placard in a retail environment. By way of further example it is also contemplated that buyer NCD 20 may use radio frequency identification (“RFID”) technology to receive a seller ID automatically when the PA is activated and buyer NCD 20 is in sufficient proximity to an RFID tag at a seller location (e.g. attached to merchandise, or attached to a seller POS device) that transmits the seller ID. It is also contemplated that the seller ID may be received by buyer manually entering a displayed alpha-numeric seller ID into a form field of the PA displayed on buyer NCD 20 using a keyboard input means.

It is contemplated that the PA may cause buyer NCD 20 to give a sensory indication to buyer (e.g. auditory, mechanical, or visual) confirming the receipt by buyer NCD 20 of a seller ID. The PA may then cause buyer NCD 20 to automatically communicate an encrypted purchase request containing the buyer ID and seller ID over a network (e.g. a telephone network or a computer network) to payment server 10, or may first require an input from buyer before sending such a purchase request. In some contemplated embodiments a purchase request may include information in addition to a buyer ID and seller ID, such as coupon information, or a buyer personal identification code (“PIC”) that is securely stored in an account record in memory of payment server 10 and preferably is otherwise known only to the buyer. As previously indicated it is contemplated that the transmission of the purchase request may be encrypted for purposes of secure transmission over the network using a conventional cryptographic protocol (e.g. SSL, TLS, OTR, TextSecure, etc. . . . )

After communicating a purchase request containing a valid buyer ID and valid seller ID buyer NCD 20 receives a purchase ticket over a communications network from payment server 10. In some embodiments it is contemplated that included with the receipt of the purchase ticket may be transaction specific instructions for generating a settlement code. It is contemplated that the communication of the purchase ticket, and any accompanying instructions, from payment server 10 may also be encrypted for secure transmission over the network using a conventional cryptographic protocol (e.g. SSL, TLS, OTR, TextSecure etc. . . . )

Buyer NCD 20 may also receive concurrently with the purchase ticket a product message. The product message may contain advertisements from other sellers that are similarly classified in terms of the goods or services known to be offered by the seller identified in the purchase request, and/or may contain advertisements, coupons, or promotions from the seller identified in the purchase request for goods or services offered by the seller. It is contemplated that the PA would cause the buyer NCD 20 to display any received product message and provide buyer an opportunity to take any action on buyer NCD 20 in response to the displayed product message, such as selecting a link to a website containing further information, accepting a coupon by selecting a link, dismiss or remove the product message, etc. . . .

Upon the buyer taking any necessary action in response to a received product message, if any, it is contemplated that the PA would require buyer to manually enter a buyer PIC and a buyer validation input into the PA using a keyboard means (physical or touchscreen) on buyer NCD 20. In a preferred embodiment it is contemplated that the required buyer validation input would be a currency amount for the transaction the buyer wishes to complete. Other data may also be included in the buyer validation input, such as for example transaction related information (e.g. invoice numbers, PO numbers, terminal numbers,) and/or other predefined counter-fraud measures and protocols such as the buyer's social security number, zip code, answers to security questions etc. . . . The PA then causes buyer NCD 20 to cipher an encrypted settlement code from the received purchase ticket, the buyer PIC, and the buyer validation input.

The PA of buyer NCD 20 causes buyer NCD 20 to communicate the settlement code from buyer NCD 20 to seller NCD 30. It is contemplated that in a preferred embodiment the PA would have the capability of generating and displaying the settlement code as a machine-readable code on a display of buyer NCD 20. The machine-readable code may be a bar code as is well known in the art, such as for example those defined by PDF 417 or Code 128 standards. It is contemplated in such an embodiment that seller NCD 30 would be capable of receiving the settlement code by scanning such machine-readable code from the display of buyer NCD 20. While use of a machine-readable code to communicate the settlement code is preferred, any other method may be used to communicate the settlement code, including but not limited to electronically communicating such settlement code over a telephone or computer network connection, a Bluetooth connection, a RFID connection, or displaying the settlement code as an alpha-numeric string that a seller can manually enter into seller NCD 30 using a keyboard means.

After communication of the settlement code it is contemplated that the PA on buyer NCD 20 shall display to buyer a purchase confirmation message received over a network connection from payment server 10. The purchase confirmation message may communicate information confirming that the transaction was successfully completed, or communicate information that the transaction was unable to be completed. Information in the purchase confirmation message may be stored in memory of the PA on buyer NCD 20 as part of a usage or transaction history accessible to the buyer at a future time through the PA on buyer NCD 20.

It is further contemplated that in a preferred embodiment a product message may be received by buyer NCD 20 concurrently with, or in close temporal proximity to, any purchase confirmation message received. The product message may contain advertisements or information from advertisers that are similarly classified in terms of the goods or services known to be offered by the seller identified in the purchase request, and/or may contain advertisements, coupons, or promotions from the seller identified in the purchase request for goods or services offered by the seller, and/or which may be complementary to a product or service purchased by buyer in the transaction. It is contemplated that the PA would display on buyer NCD 20 any received product message and provide buyer an opportunity to take any action in response to the displayed product message, such as selecting a link to a website containing further information, accepting a coupon by selecting a link, dismiss or remove the product message, etc. . . .

In a preferred embodiment of the present invention a registered user of the payment server who is acting as a seller in a transaction uses their seller NCD 30 to receive the settlement code from buyer NCD 20. In a preferred embodiment it is contemplated that the settlement code is received by seller NCD 30 through scanning a machine-readable code (e.g. a barcode) from a display of buyer NCD 20. However, the settlement code may be received by seller NCD 30 using any input means of seller NCD 30, such as for example receiving the settlement code communicated over a communications network (e.g. as a SMS text message over a telephone network), through near field contact less communication (e.g. RFID or Bluetooth), or through making a manual entry (i.e. using a keyboard means) in the PA on seller NCD 30 of a settlement code displayed alpha-numerically by the buyer NCD.

It is contemplated in a preferred embodiment of the present invention that upon receiving a settlement code input the PA on seller NCD 30 would require a seller validation input. A seller validation input is used to confirm agreement by the seller as to basic terms of the transaction and/or confirm the identity of buyer. Accordingly, a seller validation input may be the currency amount of the transaction. The seller validation input may also be buyer identifying information such as, for example, a driver's license number or telephone number.

In a preferred contemplated embodiment upon receiving a seller validation input the PA causes seller NCD 30 to determine if the seller validation input matches the buyer input validation in such respects as is necessary to confirm that buyer and seller agree on essential terms (e.g. the transaction amount). Upon verifying that the seller validation input matches the buyer input validation the PA causes seller NCD 30 to cipher a preferably encrypted payment request code from the settlement code. In addition to the settlement code, the ciphered payment request code may also include additional data related to the transaction such as, for example, seller validation input, information on products or services being purchased, any coupons or special offers being redeemed by buyer, etc. . . . Some or all of such data may be utilized by payment server 10 to process the transaction and/or be stored by payment server 10 as market data. Such market data may be used to facilitate payment server 10 identifying and delivering product messages (e.g. accompanying a payment confirmation) to buyer, and/or providing useful marketing and sales analytics to the seller or advertisers.

The PA on seller NCD 30 causes seller NCD 30 to communicate the payment request code over a communications network, such as a telephone network or computer network, to payment server 10. In some preferred embodiments the payment request code may be communicated from seller NCD 30 to an intermediate third party merchant account processor for the seller. In such an embodiment the intermediate third party merchant account processor communicates at least a portion of the payment request code to payment server 10 for processing and validation.

After communication of the payment request code it is contemplated that the PA of seller NCD 30 shall display a payment confirmation message received over a network connection from payment server 10 (e.g. directly or through a third party merchant account processor of seller). The payment confirmation message may communicate information confirming that the transaction was successfully completed, or communicate information that the transaction was unable to be completed.

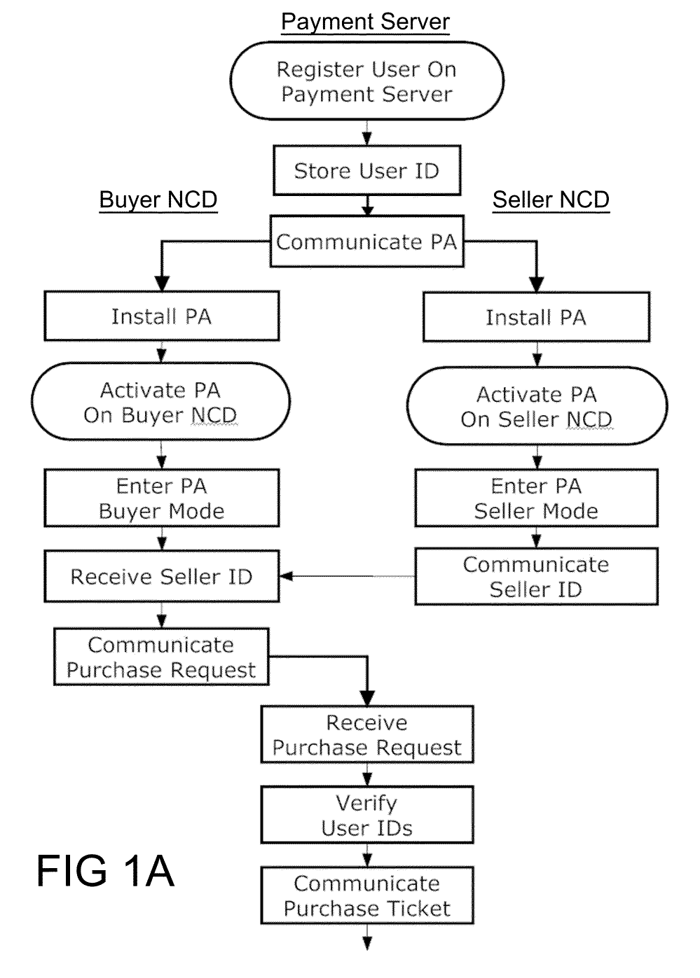

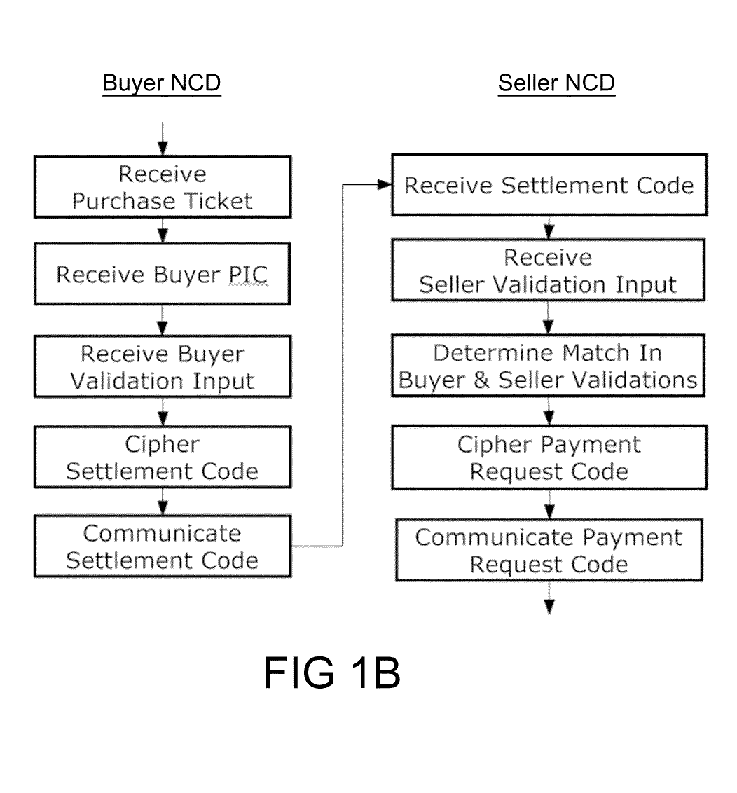

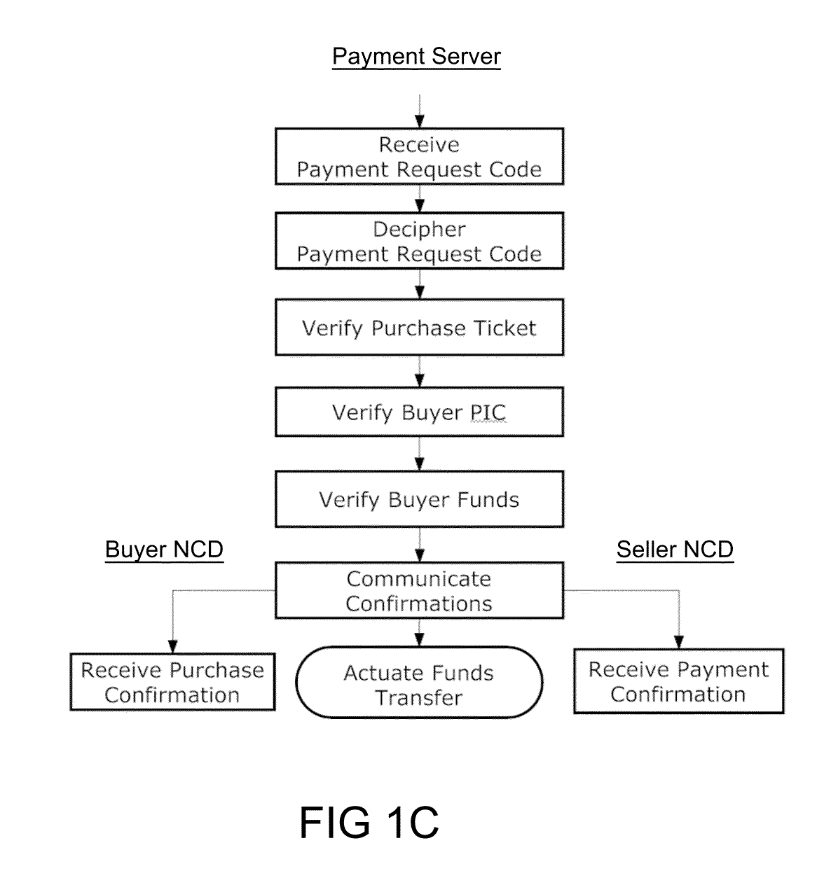

FIG. 1 illustrates an exemplary process of using a contemplated embodiment of the present invention for electronic commerce. A buyer and seller register with payment server 10 as users, each one receiving a unique user identifier (ID). A payment application (PA) is communicated to the networked computing device (NCD) of the buyer and the seller. It should be noted that the buyer and seller may, and probably will, register with payment server, and receive a PA independently at different times and places.

A registered buyer interested in completing a transaction with a registered seller for the purchase of goods or services activates the PA on buyer NCD 20. The PA acquires a seller ID for the seller, such as for example through buyer NCD 20 camera system scanning a machine-readable code (e.g. a barcode) that is displayed with the merchandise or services desired to be purchased. Upon receiving the seller ID the buyer NCD 20 transmits a purchase request over a communications network, such as a telephone or computer network, to payment server 10. The transmitted purchase request comprises at least the seller ID and the buyer ID.

Payment server 10 receives the purchase request transmitted by buyer NCD 20 and deciphers the buyer ID and seller ID from the purchase request. The TPA of payment server 10 causes payment server 10 to verify from account records in server memory that the buyer ID and seller ID are valid. Upon verification of the buyer ID and seller ID payment server 10 communicates to buyer NCD 20 over a communications network, such as a cellular telephone network, a purchase ticket. In a preferred embodiment the communicated purchase ticket is selected from a purchase ticket database in payment server memory storing a plurality of unique purchase tickets that do not contain any user identifying information. Upon communication the payment server updates its records stored in server memory to show that the communicated purchase ticket is pending for use in a transaction between the identified buyer and seller.

Buyer NCD 20 receives the purchase ticket communicated by payment server 10, and the PA of buyer NCD 20 causes buyer NCD 20 to prompt and receive a buyer PIC and a buyer validation input from buyer which is preferably a transaction amount. The PA of buyer NCD 20 causes buyer NCD 20 to cipher the purchase ticket, buyer PIC, and buyer validation input into a settlement code that is preferably encrypted. PA then causes the settlement code to be communicated by buyer NCD 20 to seller NCD 30. In a preferred embodiment of the present invention the PA causes buyer NCD 20 to generate the settlement code for communication in the form of a machine-readable code (e.g. a barcode) that can be displayed on a display of buyer NCD 20 for scanning by seller NCD 30.

Seller NCD 30 receives the settlement code from buyer NCD 20, and the PA on seller NCD 30 then causes seller NCD 30 to receive a seller validation input, such as for example through manual entry on a keyboard means of the transaction amount. The PA on seller NCD 30 causes seller NCD 30 to cipher a payment request code, preferably encrypted, from the settlement code such that the payment code may be deciphered by payment server 10 to obtain the purchase ticket, buyer PIC, and the transaction amount. The PA on seller NCD 30 causes seller NCD 30 to communicate the payment request code over a communications network, such as a cellular telephone network, to the payment server.

Payment server 10 receives over a network the payment request code from seller NCD 30. The instructions of the TPA of payment server 10 cause payment server 10 to decipher the settlement code into its constituent elements to obtain the contained purchase ticket, buyer PIC, buyer validation input, and the seller validation input. See FIG. 3. The TPA instructions cause payment server 10 to verify that the purchase ticket from the settlement code matches a purchase ticket stored in server memory as pending for a transaction between a buyer and seller. The TPA instructions cause payment server 10 to identify the buyer and seller from such verified purchase ticket. The TPA instructions cause payment server 10 to verify the buyer PIC using an account record for the identified buyer stored in payment server memory. In some embodiments where buyer validation input and seller input validation are transmitted with or included in the payment request code the TPA instructions cause payment server 10 to verify that buyer validation input matches the seller validation input (e.g. the currency amount from the buyer validation input matches the currency amount from seller validation input). The TPA instructions cause payment server 10 to verify from account records that buyer funds or credit available are sufficient for the amount of the transaction communicated in the payment request code.

The instructions of the TPA cause the payment server 10 to communicate over a network a payment confirmation message to seller NCD 30. The payment confirmation message may communicate information confirming that the transaction was successfully completed, or communicate information that the transaction was unable to be completed. Concurrently, the TPA of payment server 10 generates and communicates over a network a purchase confirmation message to buyer NCD 20. The purchase confirmation message may communicate information confirming that the transaction was successfully completed, or communicate information that the transaction was unable to be completed. The instructions of the TPA may further cause payment server 10 to actuate the transfer of funds from an account of buyer to an account of seller.

The TPA instructions of payment server 10 may in some preferred embodiments cause payment server 10 to communicate to buyer NCD 20 a product message concurrently with the transmission of the purchase ticket in response to a purchase request, and/or with the purchase confirmation message sent upon completion of a transaction. The product message may contain product or promotional information from the particular seller the buyer is commencing or completing a transaction with, and/or from other advertising sellers who have registered accounts in the payment server.

While particular embodiments of the present invention have been shown and described, it will be obvious to those skilled in the art that based upon the teachings herein, that changes and modifications may be made without departing from this invention and its broader aspects. Therefore, the appended claims are to encompass within their scope all such changes and modifications as are within the true spirit and scope of the invention.

1. A computer-implemented method using a networked payment server to complete a purchase transaction between a registered seller having a seller networked computing device and a registered buyer having a buyer networked computing device comprising the steps of:
said payment server receives over a network a purchase request from said buyer networked computing device that comprises a buyer ID and a seller ID;
said payment server verifies that said buyer ID and said seller ID are registered;
said payment server communicates a purchase ticket stored in said server memory over a network to said buyer networked computing device;
said payment server receives over a network from said seller networked computing device a payment request code;
said payment server deciphers said payment request code for said purchase ticket and a buyer personal identification code;
said payment server verifies said purchase ticket and said buyer personal identification code;
said payment server communicates over a network a payment confirmation message to said seller networked computing device; and
said payment server communicates over a network a purchase confirmation message to said buyer networked computing device.

2. The method of claim 1 further comprising said payment server transmitting to said buyer networked computing device a product message concurrently with the communication of said purchase ticket.

3. The method of claim 1 further comprising said payment server transmitting to said buyer networked computing device a product message concurrently with the communication of said purchase confirmation message.

4. A computer system to complete a commercial transaction between a registered buyer having a buyer networked computing device and a registered seller having a seller networked computing device comprising:
a payment server having a server memory, a server processor, a network interface, and a transaction processing application in said server memory having instructions that are capable of execution on said server processor to
(a) cause said payment server to communicate over a network to said buyer networked computing device a purchase ticket stored in said server memory in response to a purchase request received over a network from said buyer networked computing device that comprises a valid buyer ID and a valid seller ID, and
(b) cause said payment server to communicate a payment confirmation message over a network to said seller networked computing device, and communicate a purchase confirmation message over a network to said buyer networked computing device, when said payment server receives a payment request code that comprises said purchase ticket, and a valid buyer personal identification code.

5. The computer system to complete a commercial transaction of claim 4 further comprising said transaction processing application having instructions in said server memory that are capable of execution on said server processor to cause said payment server to transmit to said buyer networked computing device a product message.

6. A method to complete a commercial transaction using a network comprising the steps of:
communicating a payment application over a network to a networked computing device, with said payment application having instructions capable of execution on a computer processor of said networked computing device to cause said networked computing device to
(a) receive a seller ID for a seller registered with a payment server;
(b) communicate over a network to said payment server a purchase request comprising said seller ID and a buyer ID for a buyer registered with said payment server;
(c) receive a purchase ticket over a network from said payment server;
(d) receive a buyer personal identification code of said buyer;
(e) receive a buyer validation input;
(f) cipher a settlement code from said purchase ticket, said buyer personal identification code, and said buyer validation input;
(g) communicate said settlement code for receipt by a seller networked computing device; and
(h) receive a purchase confirmation over a network from said payment server.

7. The method to complete a commercial transaction using a network of claim 6 further comprising said communicated payment application containing instructions capable of execution on said computer processor to cause said networked computing device to receive said seller ID through scanning a machine-readable code.

8. The method to complete a commercial transaction using a network of claim 6 further comprising said communicated payment application containing instructions capable of execution on said computing processor to cause said networked computing device to communicate said settlement code for receipt by said seller device through displaying said settlement code as a machine-readable code for scanning by said seller networked computing device.

9. The method to complete a commercial transaction using a network of claim 6 further comprising said communicated payment application containing instructions capable of execution on said computer processor to cause said networked computing device to communicate with said payment server over a telephone network using SMS.

10. The method to complete a commercial transaction using a network of claim 6 further comprising said communicated payment application containing instructions capable of execution on said computer processor to cause said networked computing device to communicate said settlement code for receipt by said seller networked computing device over a telephone network using SMS.

11. The method to complete a commercial transaction using a network of claim 6 further comprising said communicated payment application containing instructions capable of execution on said computer processor to cause said networked computing device to
(a) receive a settlement code from a buyer networked computing device;
(b) receive a seller validation input;
(c) cipher a payment request code from said settlement code;
(d) communicate said payment request code over a network to said payment server; and
(e) receive a payment confirmation over a network from said payment server.

12. A computer-readable storage medium containing a payment application having instructions capable of execution on a computer processor of a networked computing device to cause said networked computing device to
(a) receive a seller ID for a seller registered with a payment server;
(b) communicate over a network to said payment server a purchase request comprising said seller ID and a buyer ID for a buyer registered with said payment server;
(c) receive a purchase ticket over a network from said payment server;
(d) receive a buyer personal identification code of said buyer;
(e) receive a buyer validation input;
(f) cipher a settlement code from said purchase ticket, said buyer personal identification code, and said buyer validation input;
(g) communicate said settlement code for receipt by a seller networked computing device; and
(h) receive a purchase confirmation over a network from said payment server.

13. The computer-readable storage medium of claim 12 further comprising said payment application containing instructions capable of execution on said computer processor to cause said networked computing device to receive said seller ID through scanning a machine-readable code.

14. The computer-readable storage medium of claim 12 further comprising said payment application containing instructions capable of execution on said computer processor to cause said networked computing device to communicate said settlement code for receipt by said seller networked computing device through displaying said settlement code as a machine-readable code for scanning by said seller networked computing device.

15. The computer-readable storage medium of claim 12 further comprising said payment application containing instructions capable of execution on said computer processor to cause said networked computing device to communicate with said payment server over a telephone network using SMS.

16. The computer-readable storage medium of claim 12 further comprising said payment application containing instructions capable of execution on said computer processor to cause said networked computing device to
(a) receive from a buyer networked computer device a settlement code comprising a purchase ticket, a buyer personal identification code, and a buyer validation input;
(b) receive a seller validation input;
(c) cipher a payment request code from said settlement code;
(d) communicate said payment request code over a network to a payment server; and
(e) receive a payment confirmation over a network from said payment server.

17. A computer-readable storage medium containing a payment application having instructions capable of execution on a computer processor of a networked computing device to cause said networked computing device to
(a) receive from a buyer networked computer device a settlement code comprising a purchase ticket, a buyer personal identification code, and a buyer validation input;
(b) receive a seller validation input;
(c) cipher a payment request code from said settlement code;
(d) communicate said payment request code over a network to a payment server; and
(e) receive a payment confirmation over a network from said payment server.
